(19) United States
(12) Patent Application Publication
(10) Pub. No.: US 2022/0371309 A1
(43) Pub. Date: Nov. 24, 2022

(54) LAYERED COMPOSITE COMPRISING POLYCARBONATE AND A POLYCARBONATE BLEND FOR IMPROVED PAINTABILITY

(71) Applicant: COVESTRO INTELLECTUAL PROPERTY GMBH & CO. KG, Leverkusen (DE)

(72) Inventors: Christopher SCHIRWITZ, Leverkusen (DE); Matthias KNAUPP, Langenfeld (DE); Marius NOLTE, Köln (DE); Ralf HUFEN, Duisburg (DE); Dirk HINZMANN, Pulheim (DE); Sven SIEGEMUND, Burscheid (DE); Uwe KLIPPERT, Burscheid (DE)

(21) Appl. No.: 17/770,788

(22) PCT Filed: Oct. 28, 2020
(86) PCT No.: PCT/EP2020/080223

§ 371 Date: Apr. 21, 2022

(30) Foreign Application Priority Data
Oct. 28, 2019 (EP) 19205537.4

(51) Int. Cl. B32B 27/12; B32B 27/36; B32B 27/18; B32B 37/24; B32B 5/12

(52) U.S. Cl. CPC B32B 27/12; B32B 27/365; B32B 27/18; B32B 37/24; B32B 5/12; B32B 2260/021; B32B 2260/046; B32B 2262/106; B32B 2270/00; B32B 2255/10; B32B 2307/558; B32B 2307/732; B32B 2255/28; B32B 2255/26; B32B 2369/00; B32B 2367/00; B32B 2037/243; B32B 2305/08; B32B 2605/08; B32B 2313/04

(57) ABSTRACT

The present invention relates to a layered composite comprising a poly carbonate-based matrix, possibly containing fibres, and an outer layer of special poly carbonate-polyester blends, and also to a layered composite such as that described above and provided with painting on that side of its outer layer which is facing away from the matrix, to a method for producing these composites and also to their use for the production for example of automobile add-on parts.

The present invention relates to a layer composite composed of an optionally fibers-containing polycarbonate-based matrix and a top layer composed of special polycarbonate-polyester blends and to a layer composite as described above whose top layer is provided with a painted finish on the side facing away from the matrix, to processes for producing these composites and to the use thereof for producing automotive exterior components for example.

Polycarbonates, polycarbonate blends, for example based on PC and ASA or ABS, and polycarbonate composites, i.e. fiber-reinforced polycarbonates, have long been established in the automotive industry. They are used for example in the production of automotive exterior components. Their low weight allows the weight of the vehicle components produced therewith to be markedly reduced compared to corresponding vehicle components produced using conventional materials while leaving strength and safety unchanged. This can significantly reduce fuel consumption.

The plastic parts are coated with primer layers, so-called primers, to protect against environmental influences and paint layers to achieve optical or effect-conferring properties. Baking these coatings can result in the formation of bubbles, blisters, sink marks and cracks in the coating as shown in the experimental part of the present document. This is undesirable for esthetic reasons and can moreover result in impairment of the protective effect of the coating.

It was an object of the present invention to provide a polycarbonate-based system which may be provided with a painted finish, in particular an automotive exterior component painted finish, without the abovementioned disadvantages of the prior art.

The object was achieved through a multilayer construction made of a polycarbonate-based matrix and a top layer made of special polycarbonate-polyester blends.

The present invention provides a layer composite comprising a substrate layer S and a top layer D at least partially joined to the substrate layer S,

wherein the material of the substrate layer S comprises a first thermoplastic polymer and the material of the top layer D likewise comprises the first thermoplastic polymer,

characterized in that

the first thermoplastic polymer is an aromatic polycarbonate and

the material of the top layer D comprises the first thermoplastic polymer as a blend with a polyester component P, wherein
i) the proportion of this polyester component P is ≥2% by weight, preferably ≥5% by weight, particularly preferably ≥8% by weight, based on the total weight of the material of the top layer D and wherein the polyester component P comprises or consists of at least one polycycloalkylene terephthalate,
ii) the proportion of this polyester component P is ≥10% by weight, preferably ≥15% by weight, particularly preferably ≥17% by weight, based on the total weight of the material of the top layer D and wherein the polyester component P comprises or consists of at least one polyalkylene terephthalate,
iii) the proportion of this polyester component P is ≥20% by weight, preferably ≥30% by weight, particularly preferably ≥35% by weight, based on the total weight of the material of the top layer D and wherein the polyester component P comprises or consists of at least one polyalkylene naphthalate,
iv) the proportion of this polyester component P is ≥2% by weight, preferably ≥5% by weight, particularly preferably ≥8% by weight, based on the total weight of the material of the top layer D and wherein the polyester component P comprises a mixture or consists of a mixture of at least 2 of the following components:
   at least one polycycloalkylene terephthalate,
   at least one polyalkylene terephthalate,
   at least one polyalkylene naphthalate.

In variant iv) it is preferable to employ a mixture which comprises or consists of
at least one polycycloalkylene terephthalate and at least one polyalkylene terephthalate or
at least one polycycloalkylene terephthalate and at least one polyalkylene naphthalate or
at least one polyalkylene terephthalate and at least one polyalkylene naphthalate.

In variant iv) it is particularly preferable to use a mixture which comprises or consists of at least one polycycloalkylene terephthalate and at least one polyalkylene terephthalate.

DE 20 2017 004083 U1 discloses a multilayer construction composed of a core based on a fibers-containing thermoplastic which is preferably polypropylene or polyamide and a top layer made of a thermoplastic film which is likewise preferably made of polypropylene or polyamide (claim 1, [0014], [0041]). Polycarbonate-based systems are not mentioned. The document does not concern itself with the paintability of thermoplastics either.

According to the abovementioned subject matter according to the invention component P comprises or consists of certain polyester components (see i) to iv)). In the “comprises” embodiment the corresponding polyester component may contain for example impurities or else further plastics, for example further polyesters, wherein the latter are distinct from those recited in the other polyester components. Thus for example embodiment i) describes a polyester component P which comprises one or more polycycloalkylene terephthalate(s). In this embodiment polyalkylene terephthalates for example cannot additionally be present in the polyester component. If polyalkylene terephthalates are additionally present this is to be treated as embodiment iv).

Description of the Substrate Layer S

Polycarbonates in the context of the present invention include not only homopolycarbonates but also copolycarbonates and/or polyester carbonates; the polycarbonates may be linear or branched in known fashion. Also employable according to the invention are mixtures of polycarbonates.

The weight-average molecular weight M_{w} of the aromatic polycarbonates and polyester carbonates is in the range from 15 000 to 35 000 g/mol, preferably in the range from 20 000 to 33 000 g/mol, more preferably 23 000 to 31 000 g/mol, determined by GPC (gel permeation chromatography in methylene chloride using polycarbonate standard).

A portion of up to 80 mol %, preferably of 20 mol % to 50 mol %, of the carbonate groups in the polycarbonates employed according to the invention may be replaced by aromatic dicarboxylic ester groups. Polycarbonates of this type that incorporate not only acid radicals derived from carbonic acid but also acid radicals derived from aromatic dicarboxylic acids in the molecular chain are referred to as aromatic polyester carbonates. For the purposes of the present invention, they are subsumed within the umbrella term “thermoplastic aromatic polycarbonates”.

The polycarbonates are produced in a known manner from diphenols, carbonic acid derivatives, optionally chain terminators and optionally branching agents, and the polyester carbonates are produced by replacing a portion of the carbonic acid derivatives with aromatic dicarboxylic acids or derivatives of the dicarboxylic acids, to a degree according to the extent to which the carbonate structural units in the aromatic polycarbonates are to be replaced by aromatic dicarboxylic ester structural units.

Dihydroxyaryl compounds suitable for producing polycarbonates are those of formula (1)

HO—Z—OH (1),

in which
Z is an aromatic radical which has 6 to 30 carbon atoms and may comprise one or more aromatic rings, may be substituted and may comprise aliphatic or cycloaliphatic radicals or alkylaryls or heteroatoms as bridging elements.

Z in formula (1) preferably represents a radical of formula (2)

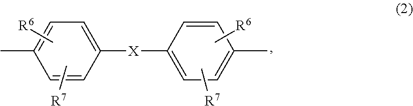

in which
R⁶ and R⁷ independently of one another represent H, C₁- to C₁₈-alkyl, C₁- to C₁₈-alkoxy, halogen such as Cl or Br or in each case optionally substituted aryl or aralkyl, preferably H or C₁- to C₁₂-alkyl, particularly preferably H or C₁- to C₈-alkyl and very particularly preferably H or methyl, and
X represents a single bond, —SO₂—, —CO—, —O—, —S—, C₁- to C₆-alkylene, C₂- to C₈-alkylidene or C₈- to C₆-cycloalkylidene which may be substituted by C₁- to C₆-alkyl, preferably methyl or ethyl, or else represents C₆- to C₁₂-arylene which may optionally be fused to further aromatic rings containing heteroatoms.

X preferably represents a single bond, C₁- to C₅-alkylene, C₂- to C₅-alkylidene, C₅- to C₆-cycloalkylidene, —O—, —SO—, —CO—, —S—, —SO₂—

or a radical of formula (3a)

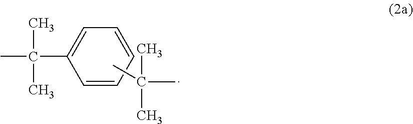

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and ring-alkylated and ring-halogenated compounds thereof.

Diphenols suitable for producing the polycarbonates to be used according to the invention are for example hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes and alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

Greatest preference is given to 2,2-bis(4-hydroxyphenyl)propane (bisphenol A).

These and other suitable diphenols are described by way of example in U.S. Pat. Nos. 2,999,835 A, 3,148,172 A, 2,991,273 A, 3,271,367 A, 4,982,014 A and 2,999,846 A, in German laid-open specifications 1 570 703 A, 2 063 050 A, 2 036 052 A, 2 211 956 A and 3 832 396 A, in the French patent specification 1 561 518 A1, in the monograph “H. Schnell, Chemistry and Physics of Polycarbonates, Interscience Publishers, New York 1964, p. 28ff and p. 102ff”, and in “D. G. Legrand, J. T. Bendler, Handbook of Polycarbonate Science and Technology, Marcel Dekker New York 2000, p. 72 ff.”.

In the case of the homopolycarbonates only one diphenol is used and in the case of copolycarbonates two or more diphenols are used. The diphenols employed, similarly to all other chemicals and assistants added to the synthesis, may be contaminated with the contaminants from their own synthesis, handling and storage. However, it is desirable to use raw materials of the highest possible purity.

The monofunctional chain terminators required for molecular-weight regulation, for example phenols or alkylphenols, in particular phenol, p-tert-butylphenol, isooctylphenol, cumylphenol, chlorocarbonic esters thereof or acyl chlorides of monocarboxylic acids or mixtures of these chain terminators, are either supplied to the reaction with the bisphenoxide(s) or else are added at any desired juncture in the synthesis provided that phosgene or chlorocarbonic acid end groups are still present in the reaction mixture or, in the case of acyl chlorides and chlorocarbonic esters as chain terminators, as long as sufficient phenolic end groups of the incipient polymer are available. However, it is preferable when the chain terminator(s) is/are added after the phosgenation at a location or at a juncture at which phosgene is no longer present but the catalyst has not yet been added or when they are added before the catalyst or together or in parallel with the catalyst.

Any branching agents or branching agent mixtures to be used are added to the synthesis in the same manner, but typically before the chain terminators. Compounds typically used are trisphenols, quaterphenols or acyl chlorides of tri- or tetracarboxylic acids, or else mixtures of the polyphenols or of the acyl chlorides.

Examples of some of the compounds employable as branching agents and having three or more than three phenolic hydroxyl groups include phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuryl chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of the optionally employable branching agents is 0.05 mol % to 2 mol % in turn based on moles of diphenols employed in each case.

The branching agents may either be initially charged with the diphenols and the chain terminators in the aqueous alkaline phase or added dissolved in an organic solvent before the phosgenation.

All of these measures for producing the polycarbonates are familiar to those skilled in the art.

Aromatic dicarboxylic acids suitable for producing the polyester carbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids include the dicarbonyl dihalides and the dialkyl dicarboxylates, especially the dicarbonyl dichlorides and the dimethyl dicarboxylates.

Replacement of the carbonate groups by the aromatic dicarboxylic ester groups is substantially stoichiometric, and also quantitative, and the molar ratio of the reactants is therefore also maintained in the final polyester carbonate. The aromatic dicarboxylic ester groups can be incorporated either randomly or blockwise.

Preferred modes of production of the polycarbonates to be used according to the invention, including the polyester carbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the former case the employed acid derivatives are preferably phosgene and optionally dicarbonyl dichlorides and in the latter case preferably diphenyl carbonate and optionally dicarboxylic diesters. Catalysts, solvents, workup, reaction conditions etc. for polycarbonate production or polyester carbonate production are sufficiently well described and known for both cases.

The material of the substrate layer S may also contain plastics other than polycarbonate as blend partners.

Employable blend partners include polyamides, polyesters, in particular polybutylene terephthalate and polyethylene terephthalate, polylactide, polyether, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl)methacrylate, polyphenylene oxide, polyphenylene sulfide, polyether ketone, polyaryl ether ketone, styrene polymers, in particular polystyrene, styrene copolymers, in particular styrene-acrylonitrile copolymer, acrylonitrile-butadiene-styrene block copolymers and polyvinyl chloride. The blend partners are employed in amounts of preferably not more than 70% by weight, particularly preferably not more than 50% by weight, very particularly preferably not more than 35% by weight, based on the total weight of polycarbonate and blend partner.

Optionally also present are up to 10.0% by weight, preferably 0.10 to 8.0% by weight, particularly preferably 0.2 to 3.0% by weight, based on the total weight of the material of the substrate layer, of other customary additives.

This group comprises flame retardants, anti-drip agents, thermal stabilizers, demolding agents, antioxidants, UV absorbers, IR absorbers, antistats, optical brighteners, light-scattering agents, colorants such as pigments, including inorganic pigments, carbon black and/or dyes, and inorganic fillers in the amounts customary for polycarbonate. These additives may be added individually or else in admixture.

Such additives as are typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich.

The substrate layer may contain one or more reinforcing fiber plies made of a fiber material. This forms fiber-containing composite materials referred to hereinbelow as fiber composite materials. The substrate layer S may also consist of two or more plies of fiber composite material and is then referred to as a multilayer composite material.

Fiber Composite Material There may be a wide variety of different chemical structures of the fibers of the fiber material.

The fiber materials have a higher softening or melting point than the thermoplastic matrix material present in each case.

The fiber material used has preferably been coated with suitable sizes.

In one embodiment of the fiber composite material the fiber ply is in the form of a unidirectional fiber ply, a woven fabric or noncrimp fabric ply, a loop-drawn knit, loop-formed knit or braid, random-laid fiber mats or nonwovens or combinations thereof. In tests, the best properties of fiber composite materials were achieved with unidirectional fiber plies, woven fabrics and noncrimp fabrics.

In the context of the present invention “unidirectional” is to be understood as meaning that the fibers are substantially unidirectionally aligned, i.e. point in the same direction lengthwise and thus have the same running direction. In the present case “substantially unidirectionally” is to be understood as meaning that a deviation from the fiber running direction of up to 5% is possible. However, it is preferable when the deviation in the fiber running direction is well below 3%, particularly preferably well below 1%.

The fiber material may be present in the form of short fibers (length <1 mm), long fibers (1 to 50 mm) or endless fibers (>50 mm). It is preferably present in the form of long fibers or endless fibers. According to the invention the fiber material is preferably ground fibers or chopped glass fibers. The meaning of the phrase “is present” is to be understood as also encompassing a mixture with other fiber materials. However, it is preferable when the respective fiber material is the only fiber material.

The term “endless fiber” in the context of the invention should be regarded as a delimitation from the short or long fibers that are likewise known to the person skilled in the art. Endless fibers generally extend over the entire length of the ply of fiber composite material. The term “endless fiber” is derived from the fact that these fibers come wound on a roll and are unwound and impregnated with plastic during production of the individual plies of fiber composite material so that, save for occasional breakage or changeover of rolls, the length of said fibers typically substantially corresponds to the length of the produced ply of fiber composite material.

Examples of fiber materials are inorganic materials such as a wide variety of different kinds of silicatic and nonsilicatic glasses, carbon, basalt, boron, silicon carbide, metals, metal alloys, metal oxides, metal nitrides, metal carbides and silicates, and organic materials such as natural and synthetic polymers, for example polyacrylonitriles, polyesters, ultrahigh-draw polyamides, polyimides, aramids, liquid-crystalline polymers, polyphenylene sulfides, polyether ketones, polyether ether ketones, polyetherimides. Preference is given to high-melting materials, for example glasses, carbon, aramids, basalt, liquid-crystal polymers, polyphenylene sulfides, polyether ketones, polyether ether ketones and polyether imides.

Particularly preferred fiber materials are glass fibers or carbon fibers.

A ply of fiber material, also referred to as fiber ply, is to be understood as meaning a sheetlike ply which is formed by fibers arranged substantially in a plane. The fibers may be joined to one another by virtue of their position relative to one another, for example by virtue of a woven fabric-like arrangement of the fibers. In addition, the fiber ply may also include a proportion of resin or another adhesive to join the fibers to one another. The fibers may alternatively also be unjoined. This is understood to mean that the fibers may be separated from one another without applying a significant force. The fiber ply may also comprise a combination of joined and unjoined fibers. At least one side of the fiber ply is embedded into the polycarbonate-based compositions employed according to the invention as matrix material. This is to be understood as meaning that the fiber ply is surrounded on at least one side, preferably on both sides, by the polycarbonate-based composition. The outer edge of the fiber composite material is preferably formed by the matrix of polycarbonate-based composition.

There is in principle no limit to the number of fiber plies in a ply of fiber composite material. It is therefore also possible for two or more fiber plies to be superposed. Two superposed fiber plies may each individually be embedded in the matrix material and thus each be surrounded by the matrix material on both sides. Two or more fiber plies may also be directly superposed, so that the entirety thereof is surrounded by the matrix material. In this case, these two or more fiber plies may also be regarded as one thick fiber ply.

Multilayer Composite Materials

Multilayer composite materials comprise at least two, preferably at least three, superposed plies of fiber composite material, wherein in the case of three composite material plies these are defined relative to one another as two outer plies of fiber composite material and at least one inner ply of fiber composite material.

Preferred fiber materials in the plies of fiber composite material are endless fibers which are preferably unidirectionally aligned.

In the case of endless fibers as fiber material the inner plies of fiber composite material may have substantially the same orientation and the orientation thereof relative to the outer plies of fiber composite material may be rotated by 30° to 90°, wherein the orientation of one ply of fiber composite material is determined by the orientation of the unidirectionally aligned fibers present therein.

In a preferred embodiment the plies are arranged alternatingly. The outer plies are here in a 0° orientation. It has been found to be particularly useful in practice when the inner plies of fiber composite material have the same orientation and the orientation thereof relative to the outer plies of fiber composite material is rotated by 90°. “Alternatingly” is to be understood as meaning that the inner plies are each by turns arranged rotated by an angle of 90° or an angle of 30° to 90°. The outer plies are each in a 0° orientation. The angles may each be varied from 30° to 90° per ply.

In a further preferred embodiment at least a portion of the plies has the same orientation and at least another portion of the plies is rotated by 30° to 90°. The outer plies are here in a 0° orientation.

In a further preferred embodiment the inner plies have the same orientation and the orientation thereof relative to the outer plies of fiber composite material is rotated by 30° to 90° and the outer plies are in a 0° orientation relative thereto.

In the case of woven fabrics, the plies of fiber composite materials are by turns stacked in the warp direction (0°) and the weft direction (90°) or at the abovementioned angles.

The fiber or multilayer composite materials may have a metallic sound. They further have the advantage that they are cost-effective to produce and are extremely lightweight due to the plastic employed therein. The fiber or multilayer composite materials further have the advantage that the shaping, for example of a housing part, may be effected particularly easily and flexibly due to the thermoformability of the composite materials.

The multilayer composite material according to the invention may in principle contain not only the plies of fiber composite material but also one or more further plies. Examples which may be mentioned here include further plies of plastic which may be identical to or different from the plastic matrix used in the plies of fiber composite material. These plastic plies may in particular also comprise fillers distinct from the fiber materials provided according to the invention. The multilayer composite material according to the invention may additionally also comprise adhesive plies, woven fabric plies, nonwoven fabric plies or surface enhancement plies, for example paint layers. These further plies may be present between inner and outer plies of fiber composite material, between two or more inner plies of fiber composite material and/or on the outer ply of fiber composite material on the side facing away from the top layer D. However it is preferable when the outer ply and the at least one inner ply of fiber composite material are joined to one another such that no further plies are arranged therebetween.

The individual plies of fiber composite material may have a substantially identical or different construction and/or orientation.

A “substantially identical construction” of the plies of fiber composite material in the context of the invention is to be understood as meaning that at least one feature from the group comprising chemical composition, fiber volume content and layer thickness is identical.

“Chemical composition” is to be understood as meaning the chemical composition of the polymer matrix of the fiber composite material and/or the chemical composition of the fiber material such as endless fibers.

In a preferred embodiment of the invention the outer plies of fiber composite material have a substantially identical construction in terms of their composition, their fiber volume content and their layer thickness.

It is preferable when the multilayer composite material has a total thickness of 0.4 to 2.5 mm, preferably 0.7 to 1.8 mm, especially 0.9 to 1.2 mm. Practical tests have shown that the multilayer composite material according to the invention can achieve excellent mechanical properties even at these low thicknesses.

It has proven particularly advantageous when the thickness of all inner plies of fiber composite material sums to a total thickness of 200 μm to 1200 μm, preferably 400 μm to 1000 μm, particularly preferably 500 μm to 750 μm.

It is further advantageous in the context of the invention when the thickness of each of the two outer plies of fiber composite material is 100 to 250 μm, preferably 120 μm to 230 μm, particularly preferably 130 μm to 180 μm.

Fiber composite material plies preferred according to the invention have a fiber volume content of ≥30% by volume and ≤60% by volume, preferably ≥35% by volume and ≤55% by volume, particularly preferably of ≥37% by volume and ≤52% by volume. A fiber volume content of more than 60% by volume results in a deterioration in the mechanical properties of the fiber composite material. Without wishing to be bound to any scientific theories the reason for this seems to be that the fibers can no longer be adequately wetted during impregnation at such high fiber volume contents, thus leading to an increase in air inclusions and to increased occurrence of surface defects in the fiber composite material and a significant reduction in mechanical resilience.

In one embodiment of the multilayer composite material the volume content of the fiber material based on the total volume of the multilayer composite material is in the range from 30% to 60% by volume, preferably in the range 40% to 55% by volume.

In one embodiment of the invention the outer plies of fiber composite material have a fiber volume content of not more than 50% by volume, preferably not more than 45% by volume, especially not more than 42% by volume.

In a particular embodiment of the invention the outer plies of fiber composite material have a fiber volume content of at least 30% by volume, preferably at least 35% by volume, especially at least 37% by volume.

In a further particular embodiment of the invention the outer plies of fiber composite material have a lower volume content of fibers based on the total volume of the ply of fiber composite material than the at least one inner ply of fiber composite material.

The inner plies of fiber composite material may have a fiber volume content of 40% to 60% by volume, preferably 45% to 55% by volume, particularly preferably 48% to 52% by volume, based on the total volume of the ply of fiber composite material.

“% by volume” is presently to be understood as meaning the volume fraction (% v/v) based on the total volume of the ply of fiber composite material.

Production of the Fiber Composite Materials and the Multilayer Composite Materials

Methods for producing the fiber composite materials/multilayer composite materials to be employed in accordance with the invention as substrate layer S are known to those skilled in the art and described for example in EP3464471 A1 and EP3055348 B1.

Description of the Top Layer D

The material of the top layer D comprises the aromatic polycarbonate also present in the substrate layer S as a blend with a polyester component P which comprises poly(cyclo)alkylene terephthalates and polyalkylene naphthalates or mixtures of these polyesters according to claim 1.

These polyesters are reaction products of terephthalic acid or naphthalene-2,6-dicarboxylic acid or their reactive derivatives, for example the dimethyl esters of these two acids, and aliphatic or cycloaliphatic diols.

Production of the polyalkylene terephthalates and naphthalates preferably employs (ar)aliphatic diols having 3 to 12 carbon atoms, for example:

ethylene glycol, 1,4-butanediol, 1,3-propanediol, 2-ethylpropane-1,3-diol, neopentyl glycol, 1,5-pentanediol, 1,6-hexanediol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-β-hydroxyethoxyphenyl)propane and/or 2,2-bis(4-hydroxypropoxyphenyl)propane. Ethylene glycol and 1,4-butanediol are preferred.

Production of the polycycloalkylene terephthalates preferably employs cycloaliphatic diols having 6 to 21 carbon atoms, for example: 1,4-cyclohexanedimethanol, 2,2-bis(4-hydroxycyclohexyl)propane and/or 2,2,4,4-tetramethyl-1,3-cyclobutanediol. 1,4-Cyclohexanedimethanol and 2,2,4,4-tetramethyl-1,3-cyclobutanediol and mixtures thereof are preferred.

Particularly preferred polyalkylene terephthalates/naphthalates contain at least 80% by weight, preferably at least 90% by weight, based on the dicarboxylic acid component of terephthalic acid radicals/naphthalene-2,6-dicarboxylic acid radicals and at least 80% by weight, preferably at least 90 mol %, based on the diol component of ethylene glycol and/or butane-1,4-diol radicals.

Particularly preferred polycycloalkylene terephthalates contain at least 80% by weight, preferably at least 90% by weight, based on the dicarboxylic acid component of terephthalic acid radicals and at least 80% by weight, preferably at least 90 mol %, based on the diol component of 1,4-cyclohexanedimethanol and/or 2,2,4,4-tetramethyl-1,3-cyclobutanediol radicals.

The preferred poly(cyclo)alkylene terephthalates/polyalkylene naphthalates may contain in addition to terephthalic acid radicals/naphthalene-2,6-dicarboxylic acid radicals up to 20 mol %, preferably up to 10 mol %, of radicals of other aromatic or cycloaliphatic dicarboxylic acids having 8 to 14 carbon atoms or aliphatic dicarboxylic acids having 4 to 12 carbon atoms, for example radicals of phthalic acid, isophthalic acid, 4,4′-diphenyldicarboxylic acid, succinic acid, adipic acid, sebacic acid, azelaic acid, cyclohexanediacetic acid.

The preferred polyalkylene terephthalates/naphthalates may contain in addition to ethylene glycol/butane-1,4-diol radicals up to 20 mol %, preferably up to 10 mol %, of other (ar)aliphatic diols having 3 to 12 carbon atoms, for example radicals of propane-1,3-diol, 2-ethylpropane-1,3-diol, neopentyl glycol, pentane-1,5-diol, hexane-1,6-diol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di($-hydroxyethoxy)benzene, 2,2-bis(4-$-hydroxyethoxyphenyl)propane and 2,2-bis(4-hydroxypropoxyphenyl)propane.

The preferred polycycloalkylene terephthalates may contain in addition to 1,4-cyclohexanedimethanol and/or 2,2,4,4-tetramethyl-1,3-cyclobutanediol radicals up to 20 mol %, preferably up to 10 mol %, of other cycloaliphatic diols having 6 to 21 carbon atoms, for example radicals of 2,2-bis(4-hydroxycyclohexyl)propane.

The abovementioned polyesters may be branched through incorporation of relatively small amounts of tri- or tetrahydric alcohols or tri- or tetrabasic carboxylic acids, for example according to DE-A 1 900 270 and US-PS 3 692 744. Examples of preferred branching agents are trimesic acid, trimellitic acid, trimethylolethane and trimethylolpropane, and pentaerythritol.

Very particularly preferred polyalkylene terephthalates are based solely on terephthalic acid or its reactive derivatives (for example its dialkyl esters) and ethylene glycol or 1,4-butanediol.

Very particularly preferred polycycloalkylene terephthalates are based solely on terephthalic acid or its reactive derivatives (for example its dialkyl esters) and 1,4-cyclohexanedimethanol and/or 2,2,4,4-tetramethyl-1,3-cyclobutanediol.

Very particularly preferred polyalkylene naphthalates are based solely on naphthalene-2,6-dicarboxylic acid or its reactive derivatives (for example its dialkyl esters) and ethylene glycol or 1,4-butanediol.

The poly(cyclo)alkylene terephthalates and polyalkylene naphthalates may be produced by known methods (see, for example, Kunststoff-Handbuch, volume VIII, p. 695 et seq., Carl-Hanser-Verlag, Munich 1973).

The proportion of the polyester component P is very particularly preferably ≥30% by weight, yet more preferably ≥35% by weight, based on the total weight of the material of the top layer D when polyester component P according to variant i) comprises or consists of at least one polycycloalkylene terephthalate.

The proportion of the polyester component P is very particularly preferably ≥30% by weight, yet more preferably ≥35% by weight, based on the total weight of the material of the top layer D when polyester component P according to variant ii) comprises or consists of at least one polyalkylene terephthalate.

The proportion of the polyester component P is moreover preferably ≥45% by weight, most preferably ≥50% by weight, based on the total weight of the material of the top layer D when polyester component P according to variant ii) comprises or consists of polyethylene terephthalate.

The proportion of the polyester component P for all embodiments is preferably ≤60% by weight, particularly preferably ≤55% by weight, based on the total weight of the material of the top layer D.

The material of the top layer may contain further blend partners. Employable blend partners include polyamides, polyesters distinct from the above-described polyesters, polylactide, polyether, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl)methacrylate, polyphenylene oxide, polyphenylene sulfide, polyether ketone, polyaryl ether ketone, styrene polymers, in particular polystyrene, styrene copolymers, in particular styrene-acrylonitrile copolymer, acrylonitrile-butadiene-styrene block copolymers and polyvinyl chloride.

Optionally also present are up to 10.0% by weight, preferably 0.10% to 8.0% by weight, particularly preferably 0.2% to 3.0% by weight, based on the total weight of the material of the top layer D, of other customary additives. At this point reference is made to the foregoing relating to the additives under the description of the substrate layer.

The top layer D has a thickness ≤500 m, preferably ≤300 μm, particularly preferably ≤200 m, very particularly preferably ≤100 m.

The top layer D has a thickness ≥5 m, preferably ≥10 m.

Description of the Paint Layer L

Paint is the name of a liquid or else pulverulent coating material that is thinly applied to objects and through chemical or physical processes (for example evaporation of the solvent) built up into a continuous solid film.

Contemplated as paint layer L are all paints for use on polycarbonate-containing substrates known to those skilled in the art. In a preferred embodiment the paint is a paint for the field of automotive exterior component painting, wherein the paint layer L preferably comprises one or more of the following layers:
at least one primer layer G,
at least one basecoat layer B
at least one clearcoat layer K.

In the automotive sector a primer layer is to be understood as meaning coatings which optimize the adherence of paints to plastic parts, for example also after weathering. The plastic parts are thus usually coated with a primer before the color- and effect-conferring paint layer or layers are applied. In addition to adherence the primer should also contribute to stone chip protection for example. A primer may moreover be made conductive by addition of appropriate additives such as carbon blacks, thus allowing the subsequently applied layers to be applied by electrostatic spray application and thus with particularly high transfer efficiency.

Basecoat (basecoat layer) is a name for a color-conferring intermediate coating material customary in automotive painting.

A clearcoat (clearcoat layer) protects the basecoat from weathering effects as well as mechanical and chemical attack.

The number of basecoat layers and clearcoat layers to be applied is in each case not limited to one layer. It is also possible to apply two, three, four or more basecoat layers or to apply multiple alternating basecoat and clearcoat layers. The individual layers may each be completely dried or only partially dried before the next layer is applied. The latter is also referred to as a “wet-on-wet” application. For overcoating with a clearcoat too the number of layers is not limited to one.

Production of the paint layer L may employ any aqueous or organic solvent-based primers, basecoats and topcoats known to those skilled in the art.

Examples of primer layers G employable according to the invention may be found for example in EP-B 1226218 or the European patent application with application Ser. No. 18/213,389.2 still unpublished at the date of filing of the present invention.

A description of basecoat layers B employable according to the invention may be found for example in the publications U.S. Pat. No. 3,639,147, DE-A-33 33 072, DE-A-38 14 853, GB-A-2 012 191, U.S. Pat. No. 3,953,644, EP-A-260 447, DE-A-39 03 804, EP-A-320 552, DE-A-36 28 124, U.S. Pat. No. 4,719,132, EP-A-297 576, EP-A-69 936, EP-A-89 497, EP-A-195 931, EP-A-228 003, EP-A-38 127, DE-A-28 18 100 and WO-A 2017/202692.

Clearcoat layers K employable according to the invention are described for example in EP-A 3445827 and WO-A 2017/202692.

The present invention further provides a process for producing a layer composite comprising the step of:

I) joining a substrate layer S to a top layer D,

wherein the substrate layer S and the top layer D correspond to the descriptions hereinabove.

The present invention further provides a process as described hereinabove further comprising the step of:

II) applying at least one paint layer to the side of the top layer D facing away from the substrate layer S in the layer composite obtained after step I).

The layer composites according to the invention are used for example for producing automotive exterior components.

The present invention therefore further provides for the use of the layer composites according to the invention for producing automotive exterior components and to the automotive exterior components themselves obtainable therefrom.

### EXAMPLES

The present invention is elucidated in detail by the examples which follow, but without being limited thereto.

Production of the Substrate S:

For the experiments sheets of a composite material made of polycarbonate and carbon fiber (referred to hereinbelow as composite) having dimensions of 350×350 mm² were used as the substrate layer. The composites were produced by Covestro Thermplast Composite GmbH (CTC) from 8 plies of UD tape, wherein the UD tapes themselves were constructed from 40-45% by volume of unidirectionally oriented carbon fiber of the type Mitsubishi TRH-50 60M and 60-55% by volume of polycarbonate matrix (Makrolon® 3107 in color 901510). A general description of production may be found for example in WO 2018/007335 A1.

Based on the angular orientation of the carbon fibers in the individual UD tape plies the ply construction was selected such that quasi-isotropic reinforcement of the composite was achieved (0°/45°/−45°/90°/90°/−45°/45°/0°).

Production of the Top Layer D:

Thermoplastic molding compounds containing the components A to E with the formulations reported in table 1 were produced on a ZSK25 twin-screw extruder from Coperion, Werner and Pfleiderer (Germany) at melt temperatures of 250° C. to 300° C. The obtained pellet materials were subsequently used to extrude films having a thickness of about 100 μm. To this end the corresponding material was after predrying (4 h, 85-90° C.) melted in the extruder (at about 50 rpm, melt temperature 265° C. (entries 1-16 in table 1) and 300° C. (entry 17 in table 1)), and extruded onto rollers via a 450 mm slot die.

Employed Components in the Top Layer D:

Component A: linear bisphenol A polycarbonate having an average molecular weight Mw of about 31 000 g/mol and a softening temperature (VST/B 120 according to ISO 306:2014-3) of 150° C. which contains no UV absorber. The melt volume flow rate (MVR) according to ISO 1133:2012-03 was 6.0 cm³/(10 min) at 300° C. and a 1.2 kg load.

Component B1: Polybutylene terephthalate (PBT) with a melt mass flow rate (MFR) of 9.0 g/10 min to 14.5 g/10 min measured according to DIN EN ISO 1133 at a temperature of 250° C. and with a load of 2.16 kg.

Component B2: Polyethylene terephthalate (PET) having an intrinsic viscosity of 0.623 dl/g. The specific viscosity is measured in dichloroacetic acid in a concentration of 1% by weight at 25° C. The intrinsic viscosity is calculated from the specific viscosity according to the following formula:

Intrinsic viscosity=specific viscosity·0.0006907+0.063096

Component B3: Polyester based on terephthalic acid, cyclohexanedimethanol and 2,2,4,4-tetramethyl-1,3-cyclobutanediol having an inherent viscosity of 0.69-0.75 dl/g measured in a 60/40 mixture (% by wt/% by wt) of phenol/tetrachloroethane at 25° C. in a concentration of 0.5 g/100 ml.

Component B4: Polyethylene Naphthalate (PEN).

Component C: Impact modifier having core-shell morphology, a styrene-butadiene-rubber core and a grafted shell made of methyl methacrylate-styrene copolymer, a butadiene content of 68%-72% and a rubber particle size distribution between 130 nm and 160 nm.

Component D1: Talc having an average particle diameter d₅₀ of 1.2 μm, measured using a sedigraph and having an Al₂O₃ content of 0.5% by weight.

Component D2: Irganox 1076, heat stabilizer, BASF SE

Component D3: Phosphorous acid H₃PO₃ as solid.

Component E: Pentaerythrityl tetrastearate as a lubricant/demolding agent.

The composites (substrate) were then laminated on both sides with the films to be examined (top layer D) on a static laboratory press (Joos LAP 100). A polished insert (“high-gloss stamp”) and an external release agent (Frekote®, Henckel) were used.

Production of the Paint Layer L

Substances Used for Producing the Primer, Basecoat and Clearcoat Layers:

Unless otherwise stated, the substances were employed without further purification or pretreatment.

Additol XL 250, Allnex Resins Germany GmbH, DE, anionic wetting and dispersion agent for pigments

Aerosil® R 972, Evonik Resource Efficiency GmbH, DE, fumed silica matting agent

Aquatix 8421, BYK Chemie GmbH, DE, rheology-modifying wax emulsion

Bayferrox® 318 M, Lanxess AG, DE, iron oxide pigment

Bayhydrol® U 2757, Covestro AG, DE, aliphatic, anionic, hydroxy-functional polyurethane dispersion based on a mixture of aromatic polyester diol and a polycarbonate diol, co-solvent-free. Binder for producing water-thinnable 2K-PUR paints, about 52% in water/N,N-dimethylethanolamine, hydroxy content about 1.8% (calculated) based on nonvolatile proportion (1 g/l h/125° C.) according to DIN EN ISO 3251, as per data sheet of 2016-09-13.

Bayhydrol® UH 2606, Covestro AG, DE, aliphatic, polycarbonate-containing anionic polyurethane dispersion, co-solvent-free. Binder for producing water-thinnable coatings for plastic substrates and wood-based materials, about 35% in water, neutralized with N-ethyldiisopropylamine (bound as salt) in a ratio of about 35:64:1, as per data sheet of 2016-09-13.

Bayhydrol® UA 2856 XP, Covestro AG, DE, aliphatic, acrylate-modified polyurethane dispersion binder for aqueous, air- and oven-drying basecoats for 2-layer vehicle painting, plastic painting, automotive repainting, industrial painting and for low-temperature-drying functional stone chip layers.

Viscosity <100 mPa s at 23° C. (ISO 3219/A.3), as per data sheet of 2016-03-03 Bayhydur® XP 2655, Covestro AG, DE, hydrophilic polyisocyanate based on trimers of hexamethylene diisocyanate, NCO content 20.8% (ISO 11909), viscosity 3500 mPa s at 23° C. (ISO 3219/A.3), as per data sheet of 2017-06-01.

Baysilone® Paint Additive OL 17, OMG Borchers, DE, polyether-modified polysiloxane (flow control additive)

Blanc fixe micro, Sachtleben Chemie GmbH, DE, filler

Borchigel® PW 25, OMG Borchers, DE, polyurethane thickener

Butyl acetate (n-butyl acetate), Azelis Deutschland GmbH, solvent

Butyl glycol (2-butoxyethanol), BASF SE, DE, solvent

Byk® 348, BYK Chemie GmbH, DE, silicone surfactant to improve substrate wetting

Desmodur® ultra N 3390, Covestro AG, DE, aliphatic polyisocyanate (trimer of hexamethylene diisocyanate). As a hardener component for lightfast polyurethane paint systems.

NCO content 19.6% (ISO 11909), viscosity 500 mPa s at 23° C. (ISO 3219/A.3), as per data sheet of 2018-11-14.

Desmodur® ultra N 3600, Covestro AG, DE, polyisocyanate based on trimers of hexamethylene diisocyanate, NCO content 23.0% (ISO 11909), viscosity 1200 mPa s at 23° C. (ISO 3219/A.3), as per data sheet of 2017-06-01.

Desmophen® 670 BA, Covestro AG, DE, low-branched, hydroxyl-containing polyester for producing weather-resistant elastic paints.

Viscosity 3000 mPa s at 23° C. (ISO 3219/A.3), as per data sheet of 2018-03-01

Diacetone alcohol (DAA), Acros Organics, solvent

Dibutyltin dilaurate, ISO-ELEKTRA—Elektrochemische Fabrik GmbH, catalyst

N,N-Dimethylethanolamine (DMEA), Sigma Aldrich Chemie, DE, neutralizing agent

Dispex® Ultra FA 4436, BASF SE, DE, dispersing aid

Finntalc® M-15 AW, Mondo Minerals BV, NL, talc

1-Methoxy-2-propyl acetate (MPA), BASF SE, DE, solvent

R-KB-2, Sachtleben Chemie GmbH, DE, white pigment

Setalux® DA 365 BA/X, Allnex Resins Germany GmbH, DE, functional acrylate polymer-containing binder

Setaqua 6801, Allnex Belgium SA/NV, non-functional acrylate-containing copolymer

Solvent Naphtha 100 (heavy benzol), Azelis Deutschland GmbH, solvent

Stapa Hydrolan 2156 No. 55900/G Aluminium, Eckart GmbH, DE, aluminum pigment paste

Surfynol® 104 E, Evonik Resource Efficiency GmbH, DE, nonionic wetting, defoaming and dispersing aid

Tinuvin® 292 and Tinuvin® 1130, BASF SE, DE, UV stabilizers

Paint Formulations:

Primer (aqueous, two-component plastic primer PCO-0148-PS as per starting formulation published by Covestro Deutschland AG (2016-09-13 edition)): To produce component 1 first the binders were initially charged and then the further constituents weighed in in the reported sequence before the mixture was admixed with glass beads (2.85-3.45 mm) 1:1 (by volume) and then ground with a Lau Skandex BA-S20 laboratory shaker for 30 minutes. The glass beads were then removed by sieving. While stirring with a dissolver (dissolver disk 5 cm, 800 rpm) the thickener was then slowly added and the mixture stirred for a further 5 minutes. Component 1 was then adjusted with demineralized water to a cup efflux time in the 4 mm DIN cup of 25 to 30 s.

Shortly before application component 2 was incorporated while stirring with a paddle stiffer (5 min, 700 rpm) and the ready-to-use primer was applied within 30 minutes.

TABLE 1

| 2-Component primer for plastics | % by wt |
|---|---|
| Component 1 | |
| Binder: | |
| Bayhydrol ® U 2757 | 20.5 |
| Bayhydrol ® UH 2606 | 30.4 |
| Constituents: | 0.4 |
| Dispex ® Ultra FA 4436 | 0.3 |
| Surfynol ® 104 E | 0.2 |
| Byk ® 348 | 7.4 |
| R-KB-2 | 11.1 |
| Blanc fixe micro | 3.7 |
| Finntalc ® M-15 AW | 0.2 |
| Bayferrox ® 318 M | 0.6 |
| Aerosil ® R 972 | 0.2 |
| Thickener: | |
| Borchigel ® PW 25 | 0.2 |
| Demineralized water | 20.5 |
| Component 2 | |
| Desmodur ® ultra N 3600/Bayhydur ® | 4.5 |
| XP 2655 (70:30), 75% in MPA | |

Water-based metallic basecoat (one-component water-based paint HEBE 4134/1 according to starting formulation published by Covestro Deutschland AG (2016-08-23 edition)):

First, the metallic paste (table 2, part 3) was prepared in a separate vessel. To this end all constituents in table 2, part 3 were mixed in the reported sequence while stirring with a propeller stiffer. The pH was then tested (target: pH 8.0-8.5) and, if necessary, adjusted with DMEA. After stirring for a further 30 minutes at about 10.5 m/s (maximum heating to 50° C.) the paste was ready to use.

For the metallic basecoat part 1 and part 2 from table 2 were mixed with a propeller stiffer at about 5.2 m/s. Part 3 was then added and incorporated for 30 minutes at about 10.5 m/s. Finally, part 4 was added and the mixture was stirred for a further 5 minutes at 5.2 m/s. Before application the pH of the paint was adjusted to 8.0-8.5 with DMEA. The cup efflux time was adjusted to 40 s according to DIN cup 4 mm with demineralized water and the paint was filtered off through a 56 μm sieve.

TABLE 2

| Water-based metallic basecoat | % by wt |
|---|---|
| Part 1 (binder) | |
| Setaqua 6801, f.s. (Nuplex Resins bv, | 26.66 |
| Netherlands) 26.66 | |
| Bayhydrol ® UA 2856 XP | 13.71 |
| Bayhydrol ® UH 2606 | 13.71 |
| Part 2 | |
| Demineralized water | 8.00 |
| Butylglycol | 7.01 |
| DMEA, 10% in water | 3.94 |
| Part 3 (metallic paste having following | 12.59 |
| composition) | |
| Butylglycol | (41.88) |
| Setaqua B E 270 | (2.89) |
| Additol XL 250 | (4.36) |
| Stapa Hydrolan 2156 No. 55900/ | (50.64) |
| G Aluminium | |
| DMEA | (0.23) |
| Part 4 | |
| Aquatix 8421 | 4.48 |
| Demineralized water | 9.90 |

Clearcoat (solvent-based clearcoat RR 4822 according to starting formulation published by Covestro Deutschland AG (2015-09-01 edition):

To produce component 1 initially the binders were introduced. While stirring with a dissolver (dissolver disk 5 cm, 800 rpm) all further constituents in table 3, part 1 were added in the reported sequence and the mixture stirred for a further 5-10 minutes.

Shortly before application component 2 was incorporated while stirring with a paddle stirrer (5 min, 700 rpm) and the ready-to-use clearcoat was applied within 30 minutes.

TABLE 3

| Clearcoat | % by wt |
|---|---|
| Part 1 | |
| Desmophen ® 670 BA | 19.4 |
| Setalux ® DA 365 BA/X | 23.8 |
| Baysilone ® Paint Additive OL 17, | 0.5 |
| 10% in butyl acetate | |
| Dibutyltin dilaurate, 1% in butyl acetate | 1.0 |
| Tinuvin ® 292, 10% in MPA | 1.0 |
| Tinuvin ® 1130, 10% in MPA | 4.9 |
| 1-Methoxy-2-propyl acetate (MPA) | 2.5 |
| Solvent Naphtha 100 | 11.1 |
| Diacetone alcohol (DAA) | 11.1 |
| Part 2 | 5.5 |
| Desmodur ® ultra N 3390 | 20.1 |

Painting of the Substrate-Top Layer Laminates

The procedure for producing the paint formulations and subsequent painting of the substrate layer-top layer laminates is described, inter alia, in the European patent application with application Ser. No. 18/213,389.2 still unpublished at the date of filing of the present invention. First, the aqueous, two-component plastic primer was prepared as described above and applied over the entire surface with a Satajet RP gravity spray gun, 1.3 mm, air pressure 2.1 bar, in 1 cross-pass to obtain a (dry) layer thickness of 20-25 m. After application, the primer was dried for 10 min at room temperature and for 30 min at 80° C. in a forced circulation oven and stored for 16 h at room temperature.

Subsequently the one-component water-based paint was prepared as described hereinabove and likewise applied over the entire surface with a Satajet HVLP gravity spray gun, 1.2 mm, air pressure 2.1 bar, in 1 cross-pass to obtain a (dry) layer thickness of 9-12 m. The basecoat was dried for 10 min at room temperature and for 30 min at 80° C. in a forced circulation oven and stored for 3 h at room temperature.

Finally the solvent-based clearcoat was produced as described hereinabove and immediately after mixing of the masterbatch and the hardener applied with a Satajet HVLP gravity spray gun, 1.2 mm, air pressure 2.1 bar, in 1 cross-pass to obtain a (dry) layer thickness of 25-32 M. The clearcoat was dried for 10 min at room temperature and for 45 min at 80° C. in a forced circulation oven.

Visual Assessment of the Painted Overall Constructions:

The visual assessment of the surface of the overall constructions composed of the substrate layer, top layer and paint was undertaken after aging of the coated sheets for at least 16 h at 60° C. in a forced circulation oven followed by 8 h of storage at room temperature. The results of the visual assessment are shown in table 5.

A score of “1” was assigned if the painted substrate layer-top layer laminate was free from bubbles, sink marks, blisters or cracks and if fibers from the substrate underneath the film were at most minimally visible on the surface.

A score of “2” was assigned if the painted substrate layer-top layer laminate was free from bubbles, sink marks, blisters or cracks but fibers from the substrate underneath the film were visible on the surface.

A score of “3” was assigned if the coated substrate layer-top layer laminates exhibited bubbles, sink marks, blisters and/or cracks.

It was found that scores of 1 and 2 could only be achieved with a certain concentration of the polyester components B1 to B4 in the top layer while bubbles, sink marks, blisters and/or cracks always occurred after painting (example 17, score 3) without admixture of a polyester component (when using pure component A).

When using PBT (B1) and PET (B2) as polyester components, good painted finish results were achieved from a content as low as 18% by weight based on the total weight of the composition of the top layer (examples 2-4 and 6-8). When using PBT the visual appearance of the surfaces was also markedly improved from as low as 36% by weight since fibers from the substrate underneath the film were less visible at the painted surface (example 3) while when using PET this effect was only apparent from a higher concentration in the top layer (example 8).

When using B3 as the polyester component good painted finish results were achieved from a content as low as 9% by weight based on the total weight of the composition of the top layer (examples 9-12), wherein the visual appearance of the surfaces was markedly improved from 36% by weight since fibers from the substrate underneath the film were less visible at the painted surface (examples 11 and 12).

When using PEN (B4) as the polyester component good painted finish results were achieved only above a higher content of 36% by weight based on the total weight of the composition of the top layer (examples 15 and 16) while fibers from the substrate underneath the film were still visible at the painted surface to a significant extent and the score of 1 was accordingly unachievable.

TABLE 4
(E: inventive example; V: comparative example; all reported data in % by wt, based on the total weight of the composition):

| | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| | (V) | (E) | (E) | (E) | (V) | (E) | (E) | (E) | (E) | (E) | (E) | (E) | (V) | (V) | (E) | (E) | (V) |
| (A) | 80.09 | 71.19 | 53.39 | 35.6 | 80.09 | 71.19 | 53.39 | 35.6 | 80.09 | 71.19 | 53.39 | 35.6 | 80.09 | 71.19 | 53.39 | 35.6 | 100 |
| (B1) | 8.9 | 17.8 | 35.6 | 53.39 | | | | | | | | | | | | | |
| (B2) | | | | | 8.9 | 17.8 | 35.6 | 53.39 | | | | | | | | | |
| (B3) | | | | | | | | | 8.9 | 17.8 | 35.6 | 53.39 | | | | | |
| (B4) | | | | | | | | | | | | | 8.9 | 17.8 | 35.6 | 53.39 | |
| (C) | 10.0 | 10.0 | 10.0 | 10.0 | 10.0 | 10.0 | 10.0 | 10.0 | 10.0 | 10.0 | 10.0 | 10.0 | 10.0 | 10.0 | 10.0 | 10.0 | |
| (D1) | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | |
| (D2) | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | |
| (D3) | 0.01 | 0.01 | 0.01 | 0.01 | 0.01 | 0.01 | 0.01 | 0.01 | 0.01 | 0.01 | 0.01 | 0.01 | 0.01 | 0.01 | 0.01 | 0.01 | |
| (E) | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | |

TABLE 5
(E: inventive example; V: comparative example)

| Composite with film | | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| made of composition | | (V) | (E) | (E) | (E) | (V) | (E) | (E) | (E) | (E) | (E) | (E) | (E) | (V) | (V) | (E) | (E) | (V) |
| Evaluation of surface | Score | 3 | 2 | 1 | 1 | 3 | 2 | 2 | 1 | 2 | 2 | 1 | 1 | 3 | 3 | 2 | 2 | 3 |
| quality after painting | | | | | | | | | | | | | | | | | | |

1.-14. (canceled)

15. A layer composite comprising a substrate layer S and a top layer D at least partially joined to the substrate layer S,
wherein the material of the substrate layer S comprises a first thermoplastic polymer and the material of the top layer D likewise comprises the first thermoplastic polymer,
wherein
the first thermoplastic polymer is an aromatic polycarbonate and the material of the top layer D comprises the first thermoplastic polymer as a blend with a polyester component P, wherein
i) the proportion of the polyester component P is ≥2% by weight, based on the total weight of the material of the top layer D, and wherein the polyester component P comprises at least one polycycloalkylene terephthalate, or
ii) the proportion of the polyester component P is ≥10% by weight, based on the total weight of the material of the top layer D, and wherein the polyester component P comprises at least one polyalkylene terephthalate, or
iii) the proportion of the polyester component P is ≥20% by weight, based on the total weight of the material of the top layer D, and wherein the polyester component P comprises at least one polyalkylene naphthalate, or
iv) the proportion of the polyester component P is ≥2% by weight, based on the total weight of the material of the top layer D, and wherein the polyester component P comprises a mixture of at least 2 of the following components:
at least one polycycloalkylene terephthalate,
at least one polyalkylene terephthalate,
at least one polyalkylene naphthalate.

16. The layer composite as claimed in claim 15, wherein disposed on the side of the top layer D facing away from the substrate layer S there is a paint layer L which is at least partially joined to the top layer D.

17. The layer composite as claimed in claim 15, wherein the substrate layer S comprises reinforcing fibers.

18. The layer composite as claimed in claim 17, wherein the substrate layer S comprises a plurality of plies of in each case unidirectionally aligned endless fibers and the endless fibers of one ply do not have the same orientation as endless fibers of directly adjacent plies.

19. The layer composite as claimed in claim 15, wherein the first thermoplastic polymer is the homopolycarbonate based on bisphenol A, the homopolycarbonate based on 1,1-bis(4-hydroxyphenyl)-3,3,5-trimethylcyclohexane, a copolycarbonate based on the monomers bisphenol A and 1,1-bis(4-hydroxyphenyl)-3,3,5-trimethylcyclohexane or a mixture of at least two of the abovementioned polymers.

20. The layer composite as claimed in claim 15, wherein the material of the top layer D further contains an impact modifier.

21. The layer composite as claimed in claim 15, wherein the top layer D has a thickness ≤500 μm.

22. The layer composite as claimed in claim 16, wherein the paint layer L comprises at least one primer layer G, at least one basecoat layer B and at least one clearcoat layer K.

23. The layer composite as claimed in claim 22, wherein at least one of the layers comprised by the paint layer L is water-based.

24. A process for producing a layer composite, comprising the step of:
I) joining a substrate layer S to a top layer D,
wherein the material of the substrate layer S comprises a first thermoplastic polymer and the material of the top layer D likewise comprises the first thermoplastic polymer,
wherein
the first thermoplastic polymer is an aromatic polycarbonate and
the material of the top layer D comprises the first thermoplastic polymer as a blend with a polyester component P, wherein
i) the proportion of the polyester component P is ≥2% by weight, based on the total weight of the material of the top layer D, and wherein the polyester component P comprises at least one polycycloalkylene terephthalate, or
ii) the proportion of the polyester component P is ≥10% by weight, based on the total weight of the material of the top layer D, and wherein the polyester component P comprises at least one polyalkylene terephthalate, or
iii) the proportion of the polyester component P is ≥20% by weight, based on the total weight of the material of the top layer D, and wherein the polyester component P comprises at least one polyalkylene naphthalate, or
iv) the proportion of the polyester component P is ≥2% by weight, based on the total weight of the material of the top layer D, and wherein the polyester component P comprises a mixture of at least 2 of the following components:
at least one polycycloalkylene terephthalate,
at least one polyalkylene terephthalate,
at least one polyalkylene naphthalate.

25. The process as claimed in claim 24, further comprising the step of:
II) applying at least one paint layer L to the side of the top layer D facing away from the substrate layer S in the layer composite obtained according to step I).

26. The process as claimed in claim 24, wherein the substrate layer S comprises reinforcing fibers.

27. The process as claimed in claim 25, wherein the paint layer L comprises at least one primer layer G, at least one basecoat layer B and at least one clearcoat layer K and wherein optionally at least one of the layers comprised by the paint layer L is water-based.

28. An automotive exterior components comprising a layer composite as claimed in claim 15.
